(19) United States
(12) Patent Application Publication
(10) Pub. No.: US 2009/0060243 A1
(43) Pub. Date: Mar. 5, 2009

(54) Method and apparatus for communicating to a hearing aid using an aimed electro-magnetic field

(75) Inventor: Paul Roller Michaelis, Louisville, CO (US)

Correspondence Address: JOHN C. MORAN, ATTORNEY, P.C., 4120 EAST 115 PLACE, THORNTON, CO, 80233-2623, US

(73) Assignee: Avaya Technology LLC, Basking Ridge, NJ (US)

(21) Appl. No.: 11/899,328

(22) Filed: Sep. 5, 2007

(51) Int. Cl. H04R 25/00

(52) U.S. Cl. 381/331; 381/312

(57) ABSTRACT

A method and apparatus configure an audio device to communicate audio information to a hearing aid by receiving location information defining a location of a receiving inductive coil of the hearing aid; aiming a transmitting inductive coil of the audio device at the location; and controlling the transmitting inductive coil to generate an electro-magnetic field to communicate the audio information.

### TECHNICAL FIELD

This invention relates to communicating audio information from a audio device to a hearing aid via an aimed electro-magnetic field.

### BACKGROUND OF THE INVENTION

Within the prior art, it is well known to communicate audio information to a hearing aid from an audio device such as a handheld audio device or headphones using an electro-magnetic field rather than acoustic signals. A primary inductive coil in the telephone communicates the audio information to a T-coil (also referred to as a telecoil) of the hearing aid. The T-coil may be located in the ear canal or may be located outside the ear canal. For example, the T-coil for a cochlear implant may be located in the mastoid bone behind the ear.

### SUMMARY OF THE INVENTION

A method and apparatus configure an audio device to communicate audio information to a hearing aid by receiving location information defining a location of a receiving inductive coil of the hearing aid; aiming a transmitting inductive coil of the audio device at the location; and controlling the transmitting inductive coil to generate an electro-magnetic field to communicate the audio information.

### BRIEF DESCRIPTION OF THE DRAWING

FIG. 1 illustrates embodiments of a handheld audio device or headset for the transmission of an electro-magnetic field to a hearing aid;

FIGS. 2-5 illustrate views of a handheld audio device having a manually adjustable primary inductive coil;

FIGS. 6-9 illustrate views of a handheld audio device having a motor adjustable primary inductive coil;

FIGS. 10-13 illustrate views of a handheld audio device having a pair of primary inductive coils;

FIG. 14 illustrates, in block diagram form, in greater detail the computer of FIG. 1;

FIG. 15 illustrates, in flowchart form, operations of the computer of FIG. 1;

FIGS. 16 and 17 illustrate views of an earpiece for use in headphones having a manually adjustable primary inductive coil;

FIGS. 18 and 19 illustrate views of an earpiece for use in headphones having a motor adjustable primary inductive coil; and

FIGS. 20 and 21 illustrate the use of an earpiece for headphones having three stationary mounted primary inductive coils.

### DETAILED DESCRIPTION

In one embodiment, and audio device has a manually adjustable primary inductive coil for communicating audio information as an electro-magnetic field to a hearing aid. The term hearing aid is used within this application in a generic sense to include hearing aids that are positioned within the ear canal, cochlear implants, and other assistive listening devices as referred to in 36 CFR Part 1194.23(i). The primary inductive coil may also be referred to as a transmitting inductive coil. The user of the audio device can manually adjust the direction of the electro-magnetic field to achieve optimal sound quality. This allows the handheld audio device to be used with hearing aids which may have the T-coil/telecoil in the ear canal or in the mastoid bone behind the ear. The T-coil/telecoil may also be referred to as a receiving inductive coil. Further, the user is able to adjust the direction of the electro-magnetic field by changing the position of the primary inductive coil during the conversation as the user moves the handheld audio device with respect to the ear. The audio device may be a handheld audio device, an audio device having a console and a handset, or headphones. In headphones having two earpieces, there would be two independently manually adjustable primary inductive coils with one for each transmitter of the headphones which the user may adjust for optimal sound. This other embodiment would also allow for a headset to have only one manually adjustable primary inductive coil if the headset had only one transmitter for the transmission of sound or a electro-magnetic field to the user.

In another embodiment, an audio device has a primary inductive coil controlled by a motor. A controller, such as a computer or hard wired control device, either internal or external to the audio device can position the primary inductive coil so that the electro-magnetic field is aimed at the T-coil. The controller can perform this operation before an audio session starts or during the audio session. The controller can receive location information from the user or from other sources. The audio device may be a handheld audio device, an audio device having a console and a handset, or headphones. In headphones having two earpieces, there would be two independently motor adjustable primary inductive coils with one for each transmitter of the headphones which the controller may adjust for optimal sound. A headset may have only one motor adjustable primary coil if the headset has only one transmitter for the transmission of sound or an electro-magnetic field to the user. These embodiments would allow the controller to automatically adjust the primary coils upon information designating which user was using the audio device.

Another embodiment employs a plurality of primary coils for each transmitter of an audio device. Each of the plurality of primary inductive coils directs the electro-magnetic field a different location. The primary inductive coils can be manually selected or may be selected by a controller in response to input from a user or information from another source.

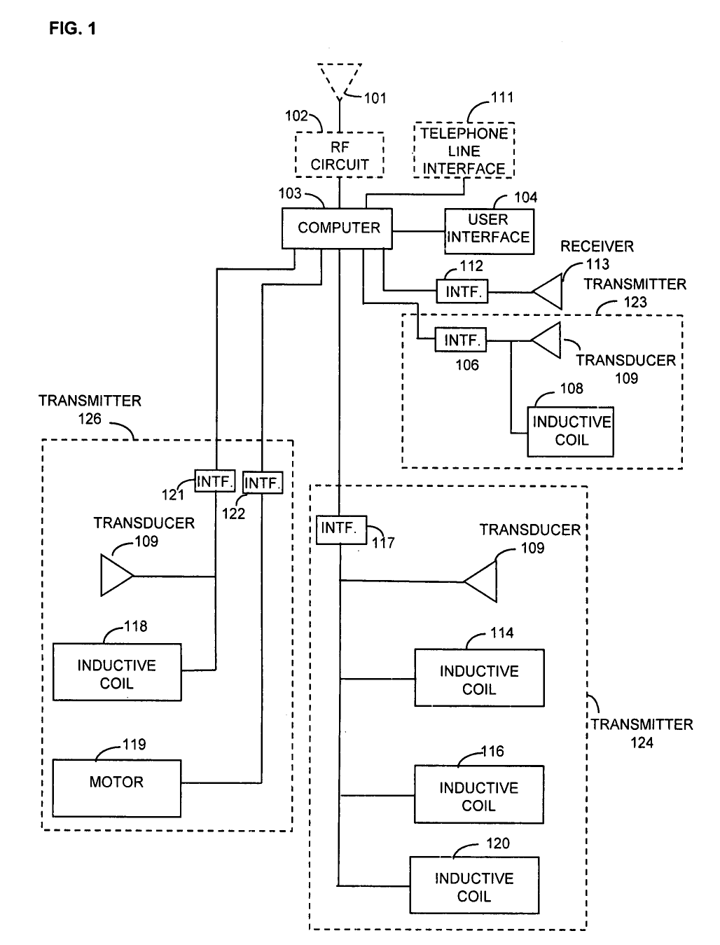

FIG. 1 illustrates, in block diagram form, a handheld audio device. Computer 103, which is shown in greater detail in FIG. 5, controls the operations of the handheld audio device. One skilled in the art would readily realize that in certain embodiments computer 103 could also be a hardwired circuit. If the handheld audio device is a wireless telephone, it has blocks 101 and 102; but if the handheld audio device is a wired telephone, it has block 111. If a wireless telephone, computer 103 controls RF circuit 102 for the transmission and reception of wireless signals both for audio information and control information. RF circuit 102 transmits and receives RF signals via antenna 101. If the handheld audio device is a wired telephone, computer 103 controls telephone line interface 111. User interface 104 provides the functions of transmitting visual information to the user and receiving key and button actuation information from the user. User interface 104 is under control of computer 103.

Computer 103 receives audio information from the user via receiver 113 and interface 112. Computer 103 transmits audio information to the user via transmitters 123, 124, or 126 depending upon the embodiment that is utilized to communicate audio information via an electro-field. Transmitters 123, 124, or 126 may also transmit audio information as acoustic signals to an ear via transducer 109 or/and as an electro-magnetic field using primary inductive coils 108 and 114-119. However, these transmitters employ different techniques for aiming the electro-field.

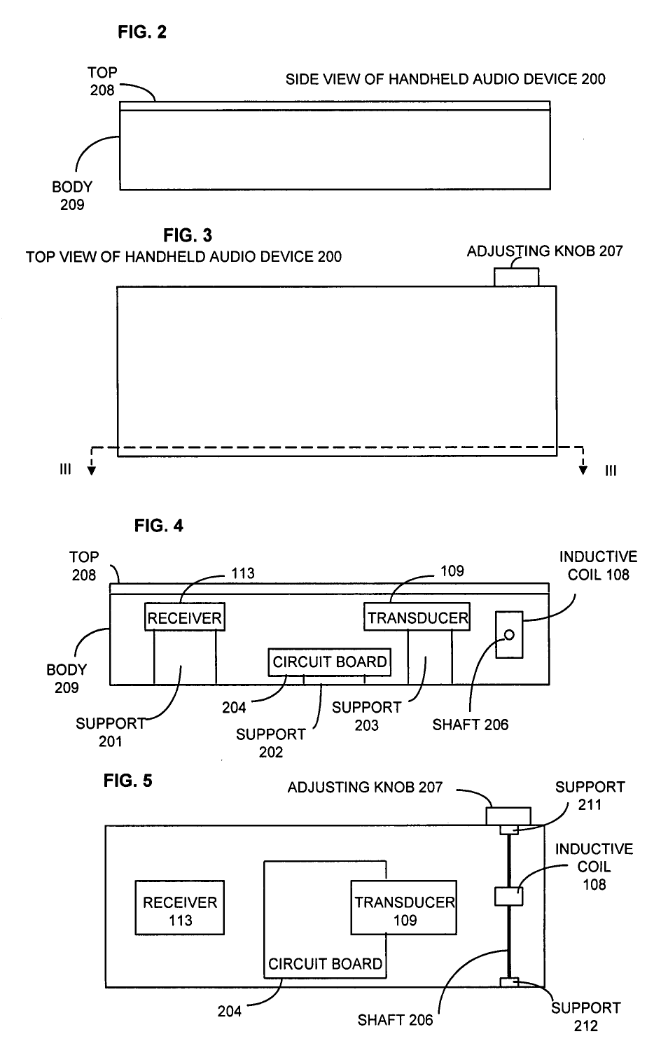

In transmitter 123, transducer 109 and inductive coil 108 are controlled by computer 103 via interface 106. As is illustrated in FIGS. 2-5, inductive coil 108 is a manually adjustable coil. The user can adjust inductive coil 108 manually to aim inductive coil 108 at the location of the T-coil.

In transmitter 124, computer 103 controls transducer 109, inductive coil 114, inductive coil 116, and inductive coil 120 via interface 117. As is illustrated in FIGS. 12 and 13, some embodiments of transmitter 124 may only use two inductive coils; whereas, as illustrated in FIG. 21 other embodiments of transmitter 124 may use three inductive coils. Computer 103 may utilize only acoustic transducer 109 and/or may utilize primary inductive coil 114 or 116 for communicating audio information to a user.

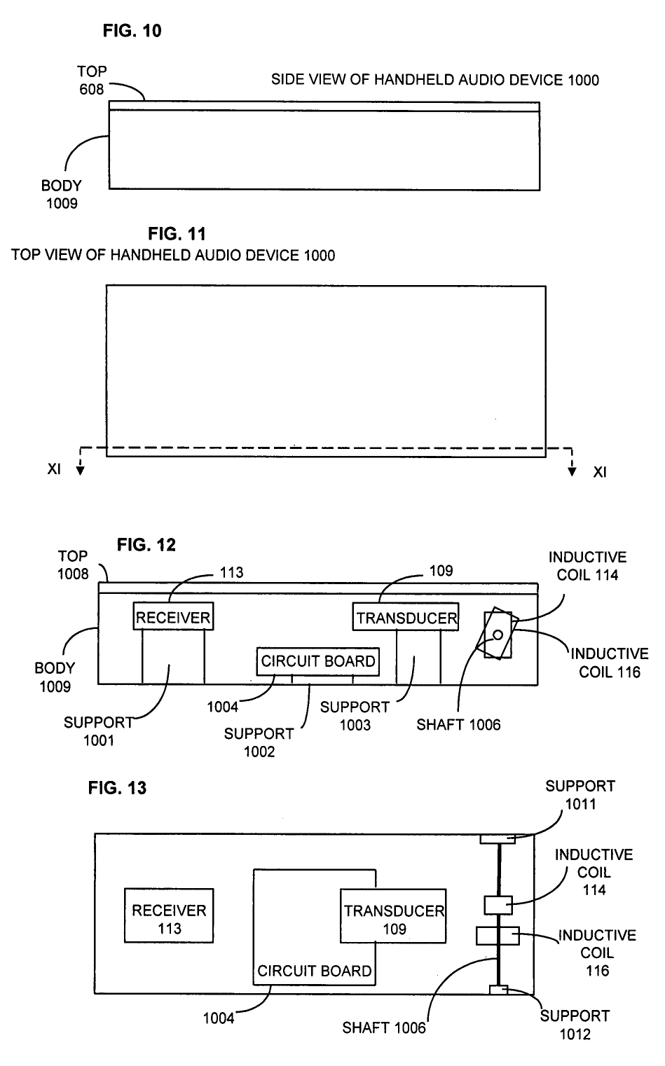

FIGS. 10-13 illustrate inductive coils 114 and 116 in greater detail in one embodiment. Primary inductive coils 114 and 116 are utilized with hearing aids that receive the audio information via T-coil as electro-magnetic fields rather than as acoustic information. Inductive coil 114 is positioned so as to communicate the maximum electro-magnetic field to a T-coil located within the ear canal. Inductive coil 116 is angled so as to communicate the maximum electro magnetic field to a hearing aid that utilizes a cochlear implant located in the mastoid bone located behind the ear.

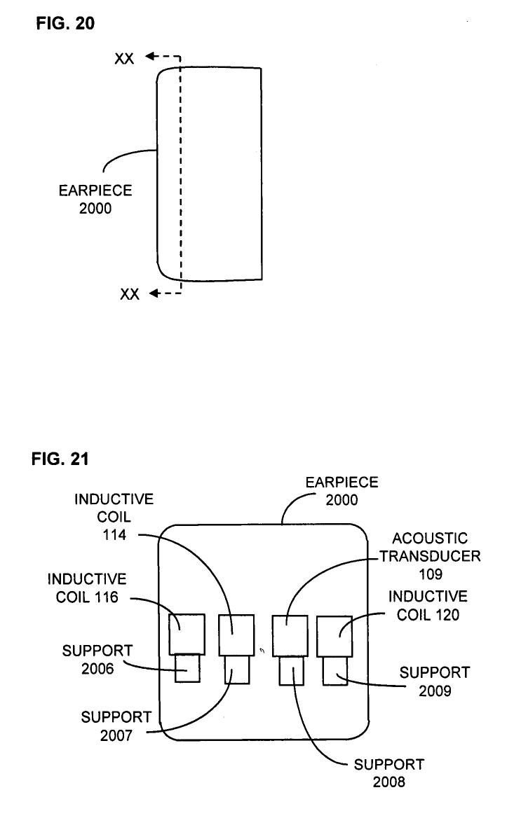

FIG. 20 illustrates inductive coils 114, 116, and 120 in greater detail in another embodiment. These coils are stationary mounted to provide a maximum electro-magnetic to various T-coil locations. Further, it will be apparent to one skilled in the art that an embodiment may require more than three primary inductive coils.

In transmitter 126, transducer 109 and inductive coil 118 are controlled by computer 103 via interface 106. As is illustrated in FIGS. 10-13, and 19, inductive coil 108 is a motor adjustable coil. The computer 103 can adjust inductive coil 108 by controlling motor 119 so as to aim inductive coil 108 at the location of the T-coil.

Although the embodiment of FIG. 1 has been described in terms of a handheld audio device or ear phones, one skilled in the art would readily realize that the embodiment of FIG. 1 could be separated into a console having blocks 101-104 and a handset having blocks 106-126. Such an embodiment could be, but is not limited to, for example, a desk telephone.

FIG. 2 illustrates a side view of handheld audio device 200 that has a manually primary adjustable inductive coil 108 which can be rotated by shaft 206 so that the electro-magnetic field can be directed to a hearing aid located within the ear canal or in the mastoid bone. Handheld audio device 200 has top 208 and body 209.

FIG. 3 illustrates a top view of handheld audio device 200. The interior of handheld audio device 200 is shown in a side view as seen by cross-section III in FIG. 4 with the side removed. Transducer 109 transmits voice signals to the user and is mounted on support 203. Receiver 113 receives voice signals from the user and is mounted on support 201. Circuit board 204 includes all of the electronic components plus the battery and antenna and is mounted on support 202. One skilled in the art could readily see that the handheld audio device could also be a wired device and would not need a battery or antenna. Inductive coil 108 can be rotated either clockwise or counterclockwise by the user utilizing adjusting knob 207.

FIG. 5 illustrates a top view of body 209 of handheld audio device 200 with the top 208 having been removed. The user can utilize adjusting knob 207 to adjust inductive coil 108 in a clockwise or counterclockwise rotation thereby allowing the user to direct the electro-magnetic field from inductive coil 118 at the location of the hearing aid. Knob 207 is attached to shaft 206 on which inductive coil 108 is mounted. Shaft 206 is retained to the body 209 by supports 211 and 212.

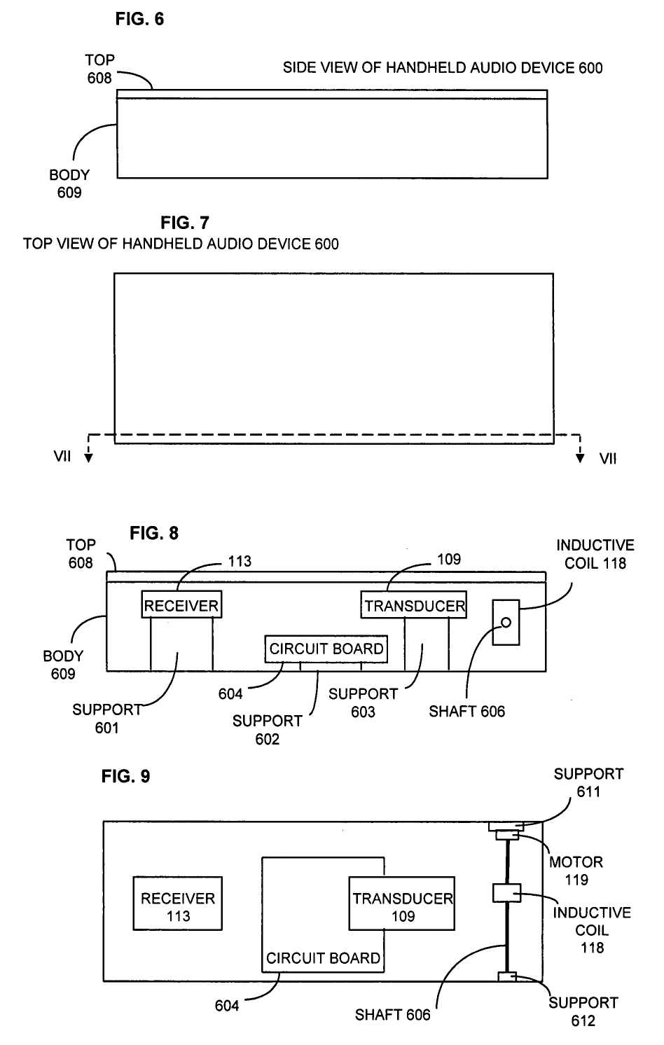

FIG. 6 illustrates a side view of handheld audio device 600 that has a primary inductive coil 118 which can be rotated on shaft 606 by motor 119 under control of computer 103 so that the electro-magnetic field can be directed to a hearing aid located within the ear canal or in the mastoid bone. Handheld audio device 600 has top 608 and body 609.

FIG. 7 illustrates a top view of handheld audio device 600. The interior of handheld audio device 600 is shown in a side view as seen by cross-section VII in FIG. 8 with the side removed. Transducer 109 transmits voice signals to the user and is mounted on support 603. Receiver 113 receives voice signals from the user and is mounted on support 601. Circuit board 604 includes all of the electronic components plus the battery and antenna and is mounted on support 602. One skilled in the art could readily see that the handheld audio device could also be a wired device and would not need a battery or antenna. Inductive coil 118 can be rotated either clockwise or counterclockwise by motor 119 under control of computer 103.

FIG. 9 illustrates a top view of body 609 of handheld audio device 600 with the top 608 having been removed. Motor 119 allows computer 103 to adjust inductive coil 118 in a clockwise or counterclockwise rotation thereby allowing computer 103 to direct the electro-magnetic field from inductive coil 118 at the location of the hearing aid. Motor 119 is attached to shaft 606 on which inductive coil 118 is mounted. Motor 119 is retained to the body 609 by support 611. Shaft 606 is also retained to the body 609 by support 612.

FIG. 10 illustrates a side view of handheld audio device 1000 that has selectable primary inductive coils 114 and 116 which can be selected by computer 103 so that the electro-magnetic can be directed to a hearing aid located within the ear canal or in the mastoid bone. Handheld audio device 1000 has top 1008 and body 1009.

FIG. 11 illustrates a top view of handheld audio device 1000. The interior of handheld audio device 1000 is shown in a side view as seen by cross-section XI in FIG. 12 with the side removed. Transducer 109 transmits voice signals to the user and is mounted on support 1003. Receiver 113 receives voice signals from the user and is mounted on support 1001. Circuit board 1004 includes all of the electronic components plus the battery and antenna and is mounted on support 1002. One skilled in the art could readily see that the handheld audio device could also be a wired device and would not need a battery or antenna. Inductive coils 114 and 116 are mounted on shaft 1006.

FIG. 13 illustrates a top view of body 1009 of handheld audio device 1000 with the top 1008 having been removed. Inductive coils 114 and 116 are mounted on shaft 1006. Shaft 1006 is retained to the body 1009 by supports 1011 and 1012.

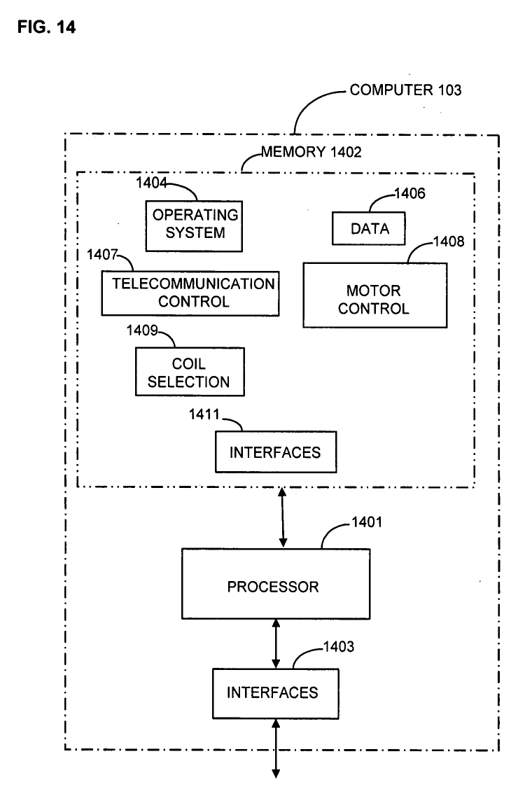

FIG. 14 illustrates, in block diagram form, computer 103 of FIG. 1. In FIG. 1, interfaces 106, 112, 117, 121, and 122 are connected to interfaces 1403 in a manner well known to those skilled in the art. Processor 1401 controls devices 108, 109, 113, 114, 116, 118, and 119 that are connected to these interfaces via interfaces 1403 by executing routines stored in memory 1402.

Interfaces routine 1412 are executed by processor 1401 to directly control the above noted devices via interfaces 1403 based on decisions made by the other routines stored in memory 1402.

Operating system 1404 provides the overall control of computer 1400 utilizing information stored in data 1406.

Telecommunication control routine 1407 controls the normal telecommunication operations of a telephone utilizing interfaces routine 1411 and information stored in data 1406.

Coil selection routine 1409 controls the selection of coils when transmitter 124 of FIG. 1 is being utilized.

Motor control routine 1408 controls motor 119 when transmitter 126 of FIG. 1 is being utilized.

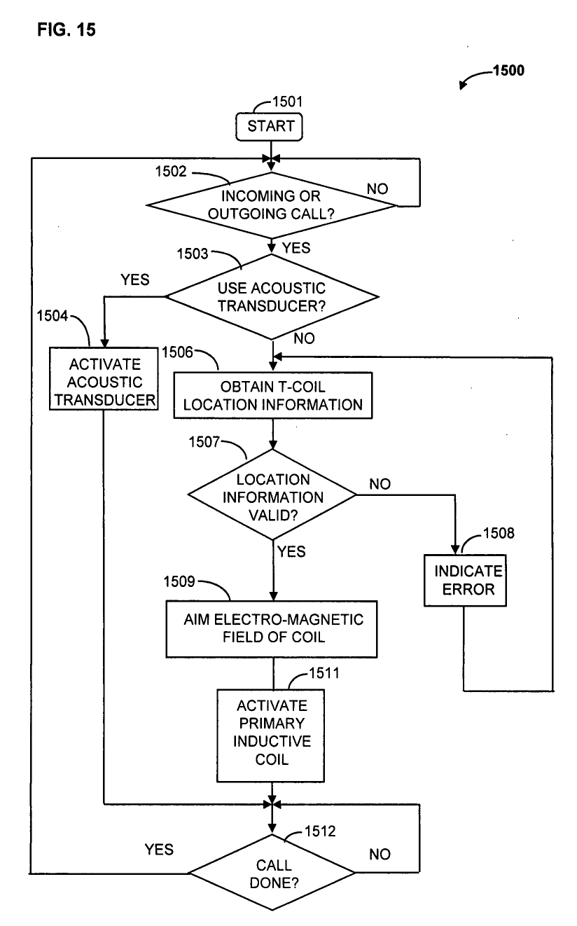

FIG. 15 illustrates, in flowchart form, operations 1500 that are performed by computer 103 if transmitter 124 or transmitter 126 is utilized in FIG. 1. After being started in block 1501, decision block 1502 determines if there is an incoming or outgoing call. If the answer is no in decision block 1502, decision block 1502 is re-executed. If the answer is yes in decision block 1502, control is transferred to decision block 1503.

Decision block 1503 determines if an acoustic transducer is to be utilized or a primary inductive coil for the communication of audio information. The user may input this information using user interface 104, or decision block 1503 may obtain this information from other sources. If the answer is yes in decision block 1503, control is transferred to block 1504 which activates the acoustic transducer before transferring control to decision block 1512.

Decision block 1512 determines if the call is done. If the answer is yes, control is transferred back to decision block 1502. If the answer in decision block 1512 is no, decision block 1512 is re-executed.

Returning to decision block 1503, if the answer is no in decision block 1503, block 1506 obtains the location of the T-coil. Block 1506 may receive this information from the user via user interface 104, or may obtain this information via other sources.

After execution of block 1506, decision block 1507 determines if the obtained location information is valid. If the answer is no, block 1508 indicates an error before returning control back to block 1506. If the answer in decision block 1507 is yes, control is transferred to block 1509.

Block 1509 aims the electro-magnetic field of the primary coil by selecting primary inductive coil 114 or primary inductive coil 116 if transmitter 124 is being used. If transmitter 126 is being used, block 1509 controls motor 119 to aim primary inductive coil 118. Next, block 1511 activates the primary inductive coil before transferring control to decision block 1512.

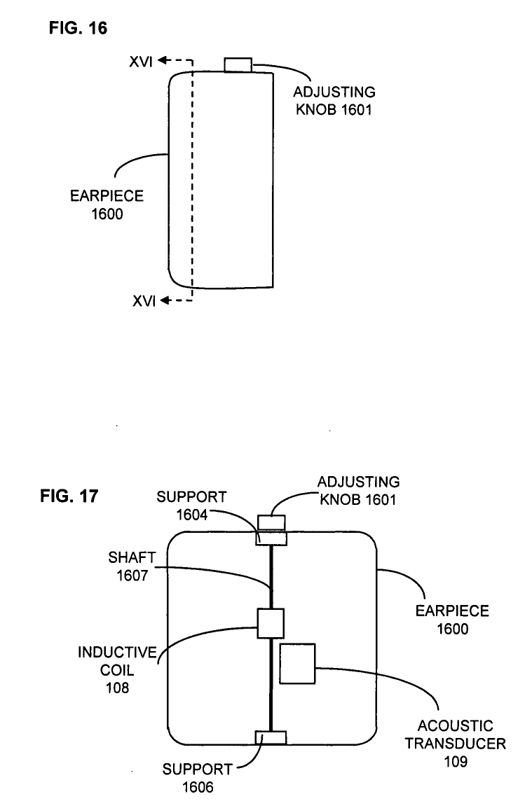

FIG. 16 illustrates a side view of earpiece 1600 for headphones that has a manually primary adjustable inductive coil 108 which can be rotated by shaft 1607 so that the electro-magnetic field can be directed to a hearing aid located within the ear canal or in the mastoid bone.

The interior of earpiece 1600 is shown in a back view as seen by cross-section XVI in FIG. 17 with the side removed. Inductive coil 108 is mounted on shaft 1607 which the user can rotate by using adjusting knob 1601. One skilled in the art could readily envision other manual adjustments that would allow inductive coil 108 to be rotated in more than one axis.

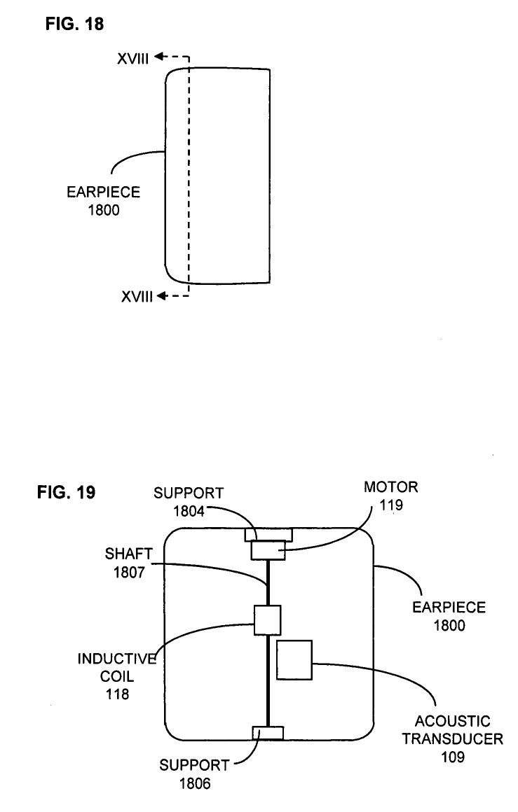

FIG. 18 illustrates a side view of earpiece 1800 for headphones that has a motor driven primary adjustable inductive coil 118 which can be rotated on shaft 1807 by motor 119 under control of computer 103 so that the electro-magnetic field can be directed to a hearing aid located within the ear canal or in the mastoid bone.

The interior of earpiece 1800 is shown in a back view as seen by cross-section XVIII in FIG. 19 with the side removed. Inductive coil 108 is mounted on shaft 1807 which is rotated by motor 119 under control of computer 103. One skilled in the art could readily envision using more than one motor so that inductive coil 108 could be rotated in more than one axis.

FIG. 20 illustrates a side view of earpiece 2000 for headphones that has three primary inductive coils one of which can be selected by computer 103 so that the electro-magnetic field can be directed to the T-coil of a hearing aid.

The interior of earpiece 2000 is shown in a back view as seen by cross-section XX in FIG. 21 with the side removed. Inductive coils 114, 116, and 120 are mounted on supports 2006, 2007, and 2009, respectively. These coils are mounted at the proper angle so one selected by computer 103 the electro-magnetic field can be directed to the T-coil of a hearing aid. Advantageously, the proper selection of either coil 116 or 120 will allow earpiece 2000 to be utilized with either the left or right ear when the T-coil is located behind the mastoid bone of either ear. One skilled in the art could readily envision the utilization of more than three inductive coils which could be arranged in other configurations.

When the operations of a computer are implemented in software, it should be noted that the software can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The computer can be embodied in any computer-readable medium for use by or in connection with an instruction execution system, apparatus, or device such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. For example, the computer-readable medium can be, but is not limited to, an electronic, magnetic, optical, electromagnetic, infrared, or semiconductor system, apparatus, or device. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

In an alternative embodiment, where the computer is implemented in hardware, the telephone set, control computer or server can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Of course, various changes and modifications to the illustrated embodiments described above will be apparent to those skilled in the art. These changes and modifications can be made without departing from the spirit and scope of the invention and without diminishing its intending advantages. It is therefore intended that such changes and modifications be covered by the following claims except insofar as limited by the prior art.

What is claimed is:

1. A method for configuring an audio device to communicate audio information to a hearing aid, comprising:
receiving location information defining a location of a receiving inductive coil of the hearing aid;
aiming a transmitting inductive coil of the audio device at the location; and
controlling the transmitting inductive coil to generate an electro-magnetic field to communicate the audio information.

2. The method of claim 1 wherein the aiming comprises selecting one of a plurality of transmitting inductive coils.

3. The method of claim 1 wherein the aiming comprises controlling a motor to position the transmitting inductive coil.

4. The method of claim 1 wherein the receiving comprises obtaining the location information from the user of the audio device.

5. The method of claim 1 wherein the audio device is a handheld audio device.

6. The method of claim 5 wherein the handheld audio device is at least one of a mobile telephone, a cellular telephone, a cordless telephone, desk telephone, a two-way radio, or a personal digital assistant.

7. The method of claim 1 wherein the audio device is a headset.

8. A method for configuring an audio device to communicate audio information to a hearing aid, comprising:
allowing a user to manually adjust a position of a transmitting inductive coil of the audio device; and
controlling the transmitting inductive coil to generate a electro-magnetic field to communicate the audio information.

9. The method of claim 8 wherein the audio device is a handheld audio device.

10. The method of claim 9 wherein the handheld audio device is at least one of a mobile telephone, a cellular telephone, a cordless telephone, a two-way radio, or a personal digital assistant.

11. The method of claim 8 wherein the audio device is a headset.

12. A computer-readable medium for configuring an audio device to communicate audio information to a hearing aid, comprising computer-executable instructions configured for:
computer-executable instructions for receiving location information defining the location of a receiving inductive coil of the hearing aid; and
computer-executable instructions for aiming a transmitting inductive coil of the audio device at the location.

13. The computer-readable medium of claim 1 wherein the aiming comprises selecting one of a plurality of transmitting inductive coils.

14. The computer-readable medium of claim 1 wherein the aiming comprises controlling a motor to position the transmitting inductive coil.

15. The computer-readable medium of claim 12 wherein the computer-executable instructions for receiving comprise computer-executable instructions for obtaining the location information from the user of the audio device.

16. The method of claim 12 wherein the audio device is a handheld audio device.

17. The computer-readable medium of claim 16 wherein the handheld audio device is at least one of a mobile telephone, a cellular telephone, a cordless telephone, a desk telephone, a two-way radio, or a personal digital assistant.

18. The method of claim 12 wherein the audio device is a headset.

19. An audio device for communicating audio information to a hearing aid, comprising:
a manually adjustable transmitting inductive coil wherein the user of the audio device can aim the manually adjustable transmitting inductive coil at a location of a receiving inductive coil of the hearing aid; and
a circuit for driving the manually adjustable transmitting inductive coil to communicate the audio information as an electro-magnetic field.

20. The method of claim 19 wherein the audio device is a handheld audio device.

21. The computer-readable medium of claim 20 wherein the handheld audio device is at least one of a mobile telephone, a cellular telephone, a cordless telephone, a desk telephone, a two-way radio, or a personal digital assistant.

22. The method of claim 19 wherein the audio device is a headset.

23. An audio device for communicating audio information to a hearing aid, comprising:
a transmitting inductive coil;
a motor for positioning the transmitting inductive coil to direct a electro-magnetic field produced by the transmitting inductive coil;
a computer for receiving location information defining the location of a receiving inductive coil of the hearing aid; and
the computer further controlling the motor to aim the electro-magnetic field generated by the transmitting inductive coil at the location.

24. The audio device of claim 23 further comprises a user interface; and
the computer further receives the location information by a user entering the location information via the user interface.

25. The method of claim 23 wherein the audio device is a handheld audio device.

26. The audio device of claim 25 wherein the handheld audio device is at least one of a mobile telephone, a cellular telephone, a cordless telephone, a desk telephone, a two-way radio, or a personal digital assistant.

27. The method of claim 23 wherein the audio device is a headset.

28. An audio device for communicating audio information to a hearing aid, comprising:
a plurality of transmitting inductive coils;
a computer for receiving location information defining the location of a receiving inductive coil of the hearing aid; and
the computer further selecting one of the plurality of transmitting inductive coils to communicate the audio information as a electro-magnetic field to the hearing aid in response to the received location information.

29. The audio device of claim 28 further comprises a user interface; and
the computer further receives the location information by a user entering the location information via the user interface.

30. The method of claim 28 wherein the audio device is a handheld audio device.

31. The computer-readable medium of claim 30 wherein the handheld audio device is at least one of a mobile telephone, a cellular telephone, a cordless telephone, a desk telephone, a two-way radio, or a personal digital assistant.

32. The method of claim 28 wherein the audio device is a headset.
